(19) United States
(12) Patent Application Publication
(10) Pub. No.: US 2017/0347373 A1
(43) Pub. Date: Nov. 30, 2017

(54) SYSTEMS AND METHODS FOR OPERATION COORDINATION BETWEEN A PLURALITY OF CO-EXISTING WIRELESS COMMUNICATION CIRCUITS

(71) Applicant: MediaTek Singapore Pte. Ltd., Singapore (SG)

(72) Inventors: Prakhar VIG, UTTAR PRADESH (IN); Rahul MAHAJAN, New Delhi (IN); Abhijit UPLENCHWAR, Uttar Pradesh (IN)

(21) Appl. No.: 15/260,634

(22) Filed: Sep. 9, 2016

(30) Foreign Application Priority Data
May 28, 2016 (IN) 201621018418

(51) Int. Cl. H04W 74/08; H04W 4/00; H04W 74/00; H04W 84/12

(52) U.S. Cl. CPC H04W 74/0816; H04W 74/002; H04W 4/008; H04W 84/12

(57) ABSTRACT

A wireless communication system including a first circuit and a second circuit is provided. The first circuit is configured to support a first wireless communication using a first wireless technology. The second circuit is configured to support a second wireless communication using a second wireless technology, determine a period of time for an activity schedule of the first wireless communication, send out a first control packet for channel reservation for the period of time plus a buffering time in response to detecting the activity schedule of the first wireless communication, and send out a second control packet within the buffering time for additional channel reservation in response to the activity schedule of the first wireless communication being extended.

### CROSS REFERENCE TO RELATED APPLICATIONS

This application claims priority of India Application No. 201621018418, filed on May 28, 2016, the entirety of which is incorporated by reference herein.

### BACKGROUND OF THE APPLICATION

### Field of the Application

The application relates generally to the coexistence between a plurality of wireless communication circuits, and more particularly, to systems and methods for operation coordination between a plurality of co-existing wireless communication circuits.

### Description of the Related Art

With growing demand for ubiquitous computing and networking, various wireless technologies have been developed, such as the Short Range Wireless (SRW) technologies, including the Wireless Fidelity (WiFi) technology, Bluetooth (BT) technology, and the ZigBee technology, etc., as well as telecommunication technologies, including the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced technology, and Time-Division LTE (TD-LTE) technology, etc.

For user convenience and flexibility, most wireless communication devices nowadays are equipped with more than one wireless communication module for supporting different wireless technologies. As shown in FIG. 1, a wireless communication device 10 may establish a wireless local area network (WLAN) via a WiFi module thereof and simultaneously communicate with a BT handset through a BT module thereof. Generally, a WLAN is implemented inside buildings as an extension to wired local area networks (LANs) and is able to provide the last few meters of connectivity between a wired network and mobile or fixed devices. According to the IEEE 802.11 standard, the WiFi module may operate in the 2.4 GHz license-free frequency band and have low throughput rates due to the interference from the co-located BT module. Referring to FIG. 1, the wireless communication device 10 serves as a WiFi station for obtaining WiFi communication services from the WiFi Access Point (AP) 20 in the established WLAN via the WiFi module. A WiFi station typically transmits and receives data to and from the WiFi AP 20. The WLAN may have a coverage varying from 20 meters in an area with obstacles (walls, stairways, elevators etc) to 100 meters in an area with a clear line of sight. For example, the wireless communication device 10 may receive web-browsing data from the Internet and transmit data to the Internet through the established WLAN.

On the other hand, the BT technology is an open wireless protocol for exchanging data over short distances between devices, creating Personal Area Networks (PANs). For example, the wireless communication device 10 may receive Voice over the Internet Protocol (VoIP) data from the Internet via the WiFi module and then forward the VoIP data to the BT handset 30 via the BT module. Alternatively, the wireless communication device 10 may receive digital media data via the WiFi module and then transmit the digital media data through the BT module to be played back in the BT handset 30.

Note that the WiFi and BT technologies both occupy a section of the 2.4 GHz Industrial, Scientific, and Medical (ISM) band, which is 83 MHz-wide. As an example shown in FIG. 2, the BT technology uses a Frequency Hopping Spread Spectrum (FHSS) and hops between 79 different 1 MHz-wide channels in a Bluetooth spectrum. The WiFi technology uses a Direct Sequence Spread Spectrum (DSSS) instead of a FHSS. A WiFi carrier remains centered on one channel, which is 22 MHz-wide. When a WiFi module and a BT module co-exist in a wireless communication device, such as in the scenario as shown in FIG. 1, the single WiFi channel, which is 22 MHz-wide, occupies the same frequency space as 22 out of 79 BT channels which are 1 MHz-wide. When a BT transmission occurs on a frequency band that falls within the frequency space occupied by an ongoing WiFi transmission, a certain level of interference may occur, depending on the signal strength thereof.

Due to the fact that the WiFi technology and BT technology share the same spectrum, operation coordination for the WiFi and BT modules co-existing in a wireless communication device is required. A conventional design proposes to use the CLEAR TO SEND (CTS)-TO-SELF (CTS-2-SELF) packet to clear the WiFi channel for BT communications. When the BT module wishes to perform BT communications, it requests the WiFi module to send out a CTS-2-SELF packet, wherein the CTS-2-SELF packet includes a Network Allocation Vector (NAV) duration indicating a period of time in which all WiFi communications in the established WLAN are not allowed. When receiving the CTS-2-SELF packet, the WiFi AP 20 has to suspend any downlink data for the wireless communication device 10, and then waits for the period of time to elapse before it can resume the transmission of downlink data to the wireless communication device 10.

As successive bursts may occur unpredictably in the BT communications, there may be a situation where the BT module needs to continue the BT communications for longer than the reserved period of time and the WiFi module would have to remain off from any WiFi communication, except to send out another CTS-2-SELF packet to reserve more time for the BT communications. However, if the successive bursts occur near the end of the reserved period of time, the successive CTS-2-SELF packet may not be sent out in time due to the WiFi channel having been occupied by the WiFi AP 20 for transmission of downlink data, as shown in FIG. 3. As a result, the successive CTS-2-SELF packet may be delayed to be sent out, which leads to excessive retries of downlink data transmission at the WiFi AP 20, causing degradation of WiFi downstream throughput.

### BRIEF SUMMARY OF THE APPLICATION

In order to solve the aforementioned problem of the conventional design, the present application proposes to extend the NAV duration by adding a buffering time to the period of time initially requested for BT communications, so as to allow the successive CTS-2-SELF packet to be sent out in time.

In one aspect of the application, a wireless communication system comprising a first circuit and a second circuit is provided. The first circuit is configured to support a first wireless communication using a first wireless technology. The second circuit is configured to support a second wireless communication using a second wireless technology, determine a period of time for an activity schedule of the first wireless communication, send out a first control packet for channel reservation for the period of time plus a buffering time in response to detecting the activity schedule of the first wireless communication, and send out a second control packet within the buffering time for additional channel reservation in response to the activity schedule of the first wireless communication being extended.

In another aspect of the application, a method for operation coordination of a wireless communication system is provided, wherein the wireless communication system comprises a first circuit configured to support a first wireless communication using a first wireless technology and a second circuit configured to support a second wireless communication using a second wireless technology. The method comprises the steps of: determining a period of time for an activity schedule of the first wireless communication; sending out a first control packet for channel reservation for the period of time plus a buffering time in response to detecting the activity schedule of the first wireless communication; and sending out a second control packet within the buffering time for additional channel reservation in response to the activity schedule of the first wireless communication being extended.

Other aspects and features of the application will become apparent to those with ordinary skill in the art upon review of the following descriptions of specific embodiments of the wireless communication systems and methods for operation coordination.

### BRIEF DESCRIPTION OF THE DRAWINGS

The application can be more fully understood by reading the subsequent detailed description and examples with references made to the accompanying drawings, wherein:

FIG. 1 shows a wireless communication device supporting both WiFi and BT communications;

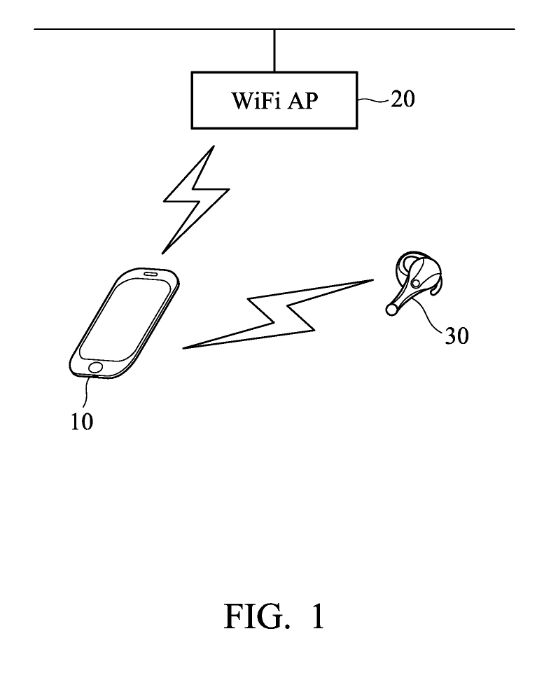

FIG. 2 shows a diagram illustrating channel specifications of WiFi and BT technologies;

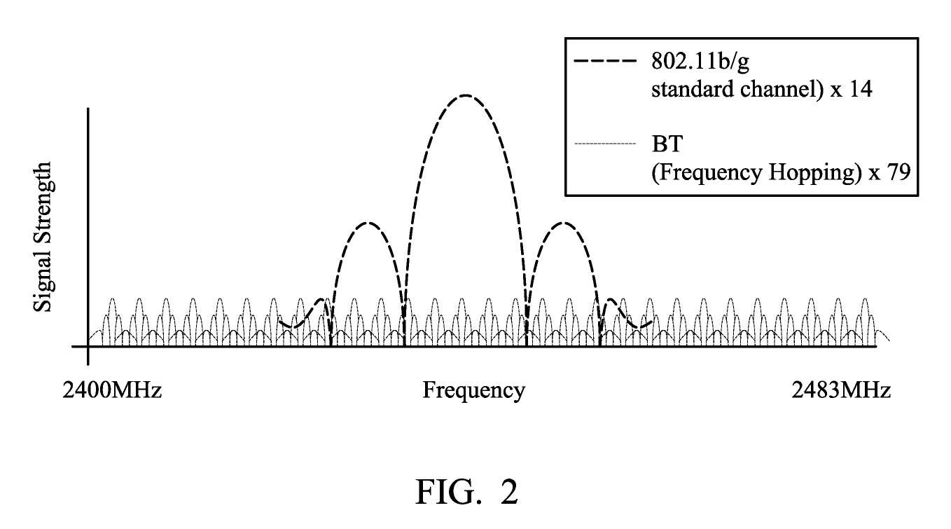

FIG. 3 is a diagram illustrating exemplary operations of the WiFi module and BT module co-existing in the wireless communication device according to the conventional design;

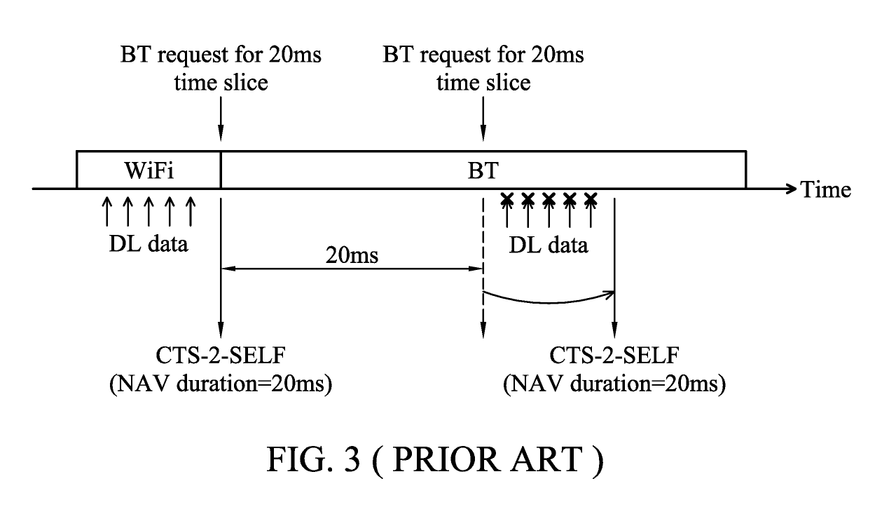

FIG. 4 is a block diagram illustrating a wireless communication system according to an embodiment of the application;

FIG. 5 is a block diagram illustrating a wireless communication system according to another embodiment of the application;

FIG. 6 is a flow chart illustrating the method for operation coordination of a wireless communication system according to an embodiment of the application; and

FIG. 7 is a schematic diagram illustrating operations of the WiFi module 410 and BT module 420 according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof.

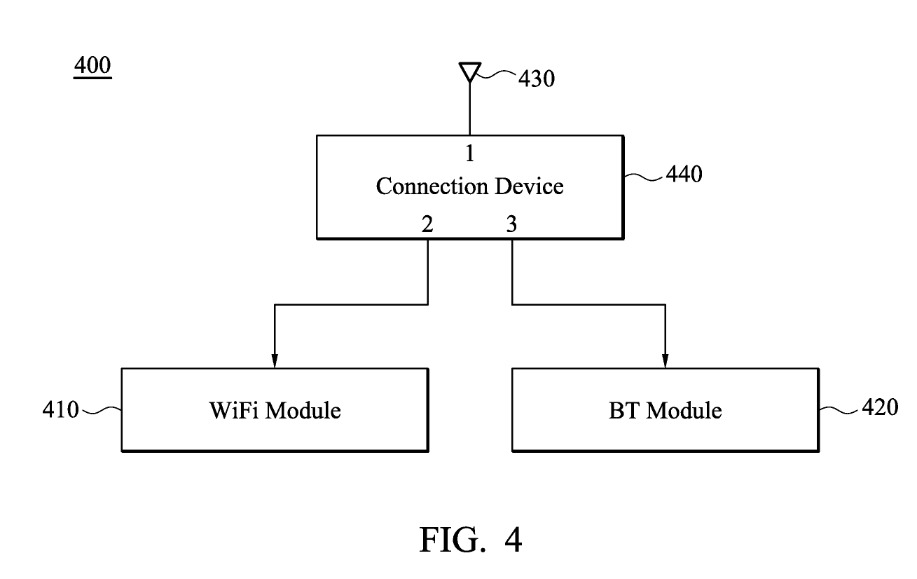

FIG. 4 is a block diagram illustrating a wireless communication system according to an embodiment of the application. The wireless communication system 400 may be any fixed or mobile device, such as a router AP, a mobile phone, a laptop computer, or a panel Personal Computer (PC), which includes multiple wireless communication modules for supporting wireless communications using multiple wireless technologies. Specifically, the wireless communication system 400 includes a WiFi module 410, a BT module 420, an antenna 430, and a connection device 440. The WiFi module 410 includes one or more circuits for supporting WiFi communications via the antenna 430. For example, the WiFi module 410 may serve as a WiFi AP for providing WiFi communication services to WiFi stations in the established WLAN, or may serve as a WiFi station for obtaining WiFi communication services from a WiFi AP in the established WLAN. The BT module 420 includes one or more circuits for supporting BT communications via the antenna 430. For example, the BT module 420 may serve as a master for coordinating BT communication throughout the established PAN, including sending data to a slave or request data from a slave, or may serve as a slave for performing BT communications by request of the master in the established PAN.

In one embodiment, each of the WiFi module 410 and the BT module 420 may contain a Radio Frequency (RF) device and a baseband processing device. The baseband processing device is configured to perform baseband signal processing and control the communications between subscriber identity card(s) (not shown) and the RF device. The baseband processing device may contain multiple hardware components to perform the baseband signal processing, including Analog-to-Digital Conversion (ADC)/Digital-to-Analog Conversion (DAC), gain adjusting, modulation/demodulation, encoding/decoding, and so on. The RF device may receive RF wireless signals via the antenna 430, convert the received RF wireless signals to baseband signals, which are processed by the baseband processing device, or receive baseband signals from the baseband processing device and convert the received baseband signals to RF wireless signals, which are later transmitted via the antenna 430. The RF device may also contain multiple hardware devices to perform radio frequency conversion. For example, the RF device may comprise a mixer to multiply the baseband signals with a carrier oscillated in the radio frequency of the supported cellular technologies, wherein the radio frequency may be 2.4 GHz, 3.6 GHz, 4.9 GHz, or 5 GHz utilized in the WiFi technology, or may be 2402˜2480 MHz, or 2400˜2483.5 MHz utilized in the BT technology, or another radio frequency, depending on the wireless technology in use.

The antenna 430 may be configured to operate at different radio frequencies according to the controlling wireless communication module. For example, if the controlling wireless communication module is the WiFi module 410, the antenna 430 may be configured to operate in a 22 MHz-wide channel selected from the 2.4 GHz license-free frequency band. If the controlling wireless communication module is the BT module 420, the antenna 430 may be configured to operate in 79 different 1 MHz-wide hopping channels selected from the 2.4 GHz license-free frequency band.

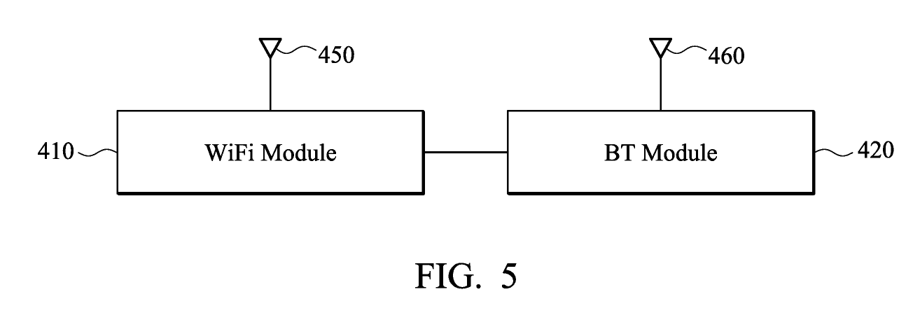

The connection device 440, which consists of three terminals 1, 2, and 3, is configured to connect the terminal 1 to either one of the terminals 2 and 3, to allow the WiFi module 410 or the BT module 420 to access the antenna 430. The connection device 440 may be implemented with a direction coupler, or any other device which may enable simultaneous transmission/reception of the WiFi module 410 and the BT module 420. Alternatively, the connection device 440 may be omitted, and the WiFi module 410 and the BT module 420 may be configured to couple to the antennas 450 and 460, respectively, for dedicated transmission and reception, as shown in FIG. 5.

Please note that the antenna 430 may be disposed outside of the wireless communication system 400, or the WiFi module 410 and the BT module 420 may be combined in a chipset, and the application is not limited thereto.

It should be understood that the components described in the embodiment of FIGS. 4 and 5 are for illustrative purposes only and are not intended to limit the scope of the application. For example, the wireless communication system 400 may include more wireless communication modules of other wireless technologies, such as the WiMAX technology, the LTE technology, the WCDMA technology, and others. In addition, the wireless communication system 400 may further include a central controller (e.g., a general-purpose processor, a Micro Control Unit (MCU), an application processor, a Digital Signal Processor (DSP), or the like), a storage device (e.g., a volatile or non-volatile memory, a hard disk, an optical disc, or any combination thereof), a display device (e.g., a Liquid-Crystal Display (LCD), Light-Emitting Diode (LED) display, or Electronic Paper Display (EPD)), and/or an input device (e.g., a button, keyboard, mouse, touch pad, video camera, microphone, and/or speaker).

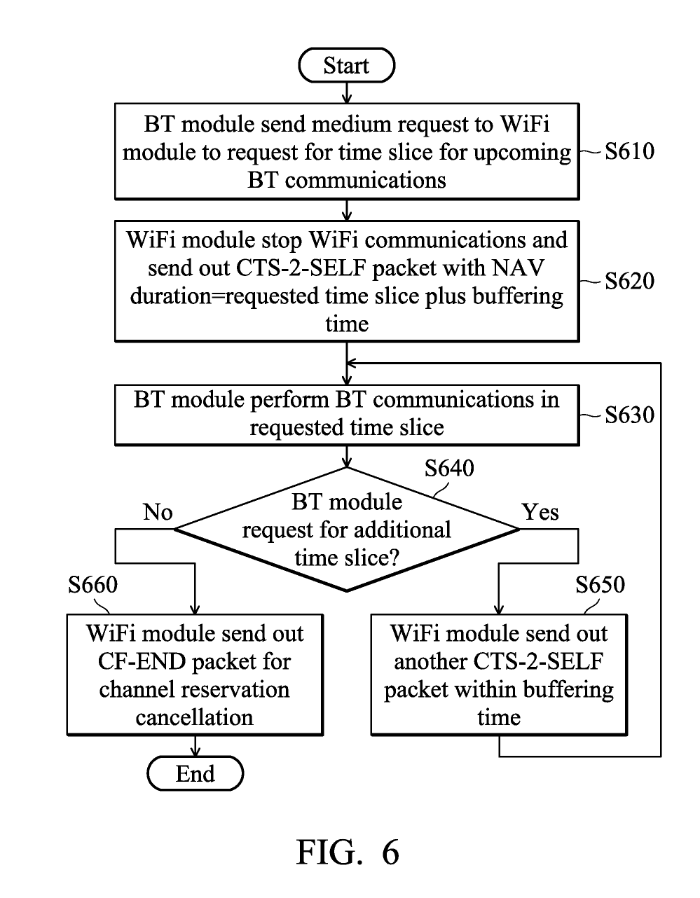

FIG. 6 is a flow chart illustrating the method for operation coordination of a wireless communication system according to an embodiment of the application. In this embodiment, the method is applied to a wireless communication system, such as the wireless communication system 400 of FIG. 4, which contains multiple wireless communication modules, including a WiFi module and a BT module, and each of the WiFi module and the BT module contains one or more circuits for operation coordination therebetween and supporting wireless communications using a respective one of the WiFi and BT technologies.

To begin, the BT module sends a medium request to the WiFi module to request for a time slice according to the activity schedule of the upcoming BT communications (step S610). In one embodiment, the activity schedule may indicate the number of BT time slots required for the upcoming BT communications, and the time slice may be determined by transforming the number of BT time slots into a value in milliseconds. For example, 32 BT time slots is equal to 20 milliseconds.

When receiving the medium request, the WiFi module stops the WiFi communications and then sends out a CTS-2-SELF packet to clear the WiFi channel for upcoming BT communications (i.e., to reserve the channel for BT communications), wherein the CTS-2-SELF packet includes a NAV duration set to the requested time slice plus a buffering time (step S620). When receiving the CTS-2-SELF packet, the WiFi AP in the established WLAN stops transmitting downlink data to the wireless communication system. Please note that the buffering time is configurable to enable the CTS-2-SELF packet to be sent out successfully. For example, the buffering time may bet set to 2 milliseconds or another value, depending on the implementation design.

Subsequently, the BT module performs BT communications in the requested time slice (step S630). Next, at the end of the requested time slice, the WiFi module determines whether another medium request for requesting additional time slice has been received from the BT module (step S640), and if so, it means that successive bursts occur at/near the end of the requested time slice, and the activity schedule of the BT communications needs to be extended.

In response to receiving another medium request, the WiFi module sends out another CTS-2-SELF packet within the buffering time, to further clear the WiFi channel for the activity schedule of the BT communications being extended, wherein the CTS-2-SELF packet includes a NAV duration set to the newly requested time slice plus the buffering time (step S650). After that, the method flow goes to step S630.

Subsequent to step S640, if no medium request has been received from the BT module, the WiFi module sends out a Contention Free-END (CF-END) packet for channel reservation cancellation and starts the WiFi communications as desired (step S660), and the method ends. Specifically, the CF-END packet is used to indicate to other WiFi stations and the WiFi AP in the established WLAN to enable WiFi communications. In one embodiment, if an ongoing WiFi reception (Rx) operation is suspended in step S620, the WiFi module may resume the suspended WiFi Rx operation.

It should be understood that, in the embodiment of FIG. 6, the CTS-2-SELF packet is employed as the first/second control packet for reserve the WiFi channel from upcoming BT communications, and the CF-END packet is employed as the third control packet for enabling the WiFi communications of the other WiFi stations and the WiFi AP in the established WLAN; while in other embodiments, the first/second control packet may be any WiFi control packet which can be used for channel reservation, and the third control packet may be any WiFi control packet which can be used for channel reservation cancellation.

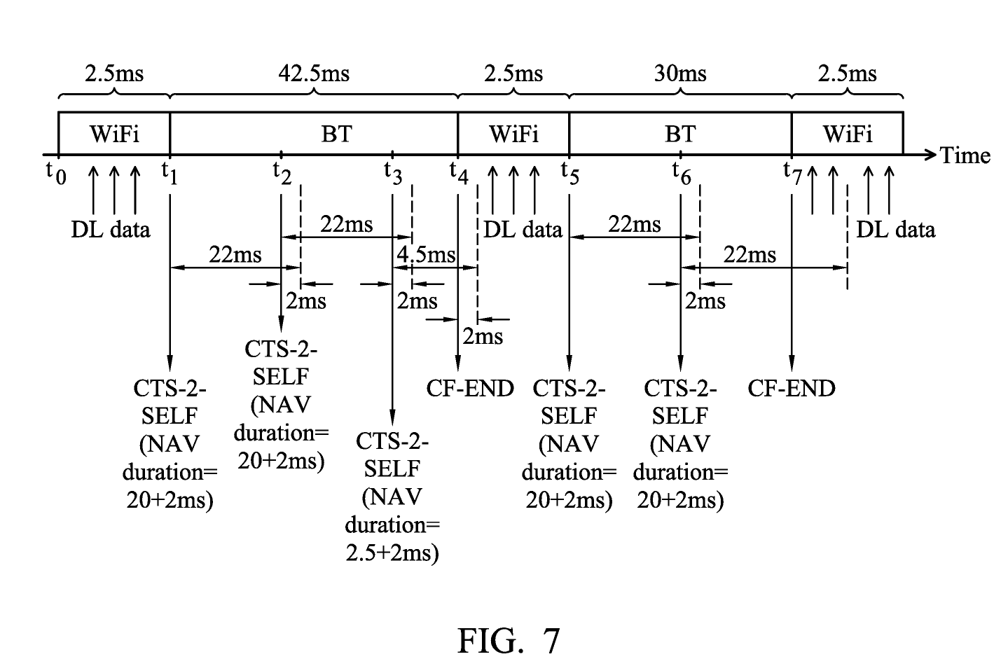

FIG. 7 is a schematic diagram illustrating operations of the WiFi module 410 and BT module 420 according to an embodiment of the application. As shown in FIG. 7, at time t₀, the WiFi module 410 starts the WiFi Rx operation for 2.5 milliseconds, and at time t₁, receives a medium request from the BT module 420, which requests for a time slice of 20 milliseconds due to that the activity schedule of the upcoming BT communications indicates 32 BT time slots. When receiving the medium request, the WiFi module stops the WiFi Rx operation and sends out a CTS-2-SELF packet including a NAV duration set to 22 milliseconds (i.e., the requested time slice of 20 milliseconds plus a buffering time of 2 milliseconds). Meanwhile, the BT module 420 starts the BT communications after sending the medium request at time t₁.

At time t₂ (i.e., the end of the requested time slice), the BT module 420 determines that the activity schedule needs to be extended for another 20 milliseconds, and then sends a medium request to the WiFi module 410. When receiving the medium request, the WiFi module 420 prepares another CTS-2-SELF packet including a NAV duration set to 22 milliseconds (i.e., the requested time slice of 20 milliseconds plus a buffering time of 2 milliseconds), and then manages to send out the CTS-2-SELF packet within the buffering time (i.e., from time t₂ to t₂+2 milliseconds). Meanwhile, the BT module 420 continues the BT communications at time t₂.

At time t₃, the BT module 420 determines that the activity schedule needs to be extended for another 2.5 milliseconds, and then sends a medium request to the WiFi module 410. When receiving the medium request, the WiFi module 420 prepares another CTS-2-SELF packet including a NAV duration set to 4.5 milliseconds (i.e., the requested time slice of 2.5 milliseconds plus a buffering time of 2 milliseconds), and then manages to send out the CTS-2-SELF packet within the buffering time (i.e., from time t₃ to t₃+2 milliseconds). Meanwhile, the BT module 420 continues the BT communications at time t₃.

At time t₄, the BT communications end, and in response, the WiFi module 410 sends out a CF-END packet to free the WiFi channel from being reserved for BT communications, and starts the WiFi Rx operation for 2.5 milliseconds.

At time t₅, the WiFi module 410 receives a medium request from the BT module 420, which requests for a time slice of 20 milliseconds due to that the activity schedule of the upcoming BT communications indicates 32 BT time slots. When receiving the medium request, the WiFi module stops the WiFi Rx operation and sends out a CTS-2-SELF packet including a NAV duration set to 22 milliseconds (i.e., the requested time slice of 20 milliseconds plus a buffering time of 2 milliseconds). Meanwhile, the BT module 420 starts the BT communications after sending the medium request at time t₅.

At time t₆ (i.e., the end of the requested time slice), the BT module 420 determines that the activity schedule needs to be extended for another 20 milliseconds, and then sends a medium request to the WiFi module 410. When receiving the medium request, the WiFi module 420 prepares another CTS-2-SELF packet including a NAV duration set to 22 milliseconds (i.e., the requested time slice of 20 milliseconds plus a buffering time of 2 milliseconds), and then manages to send out the CTS-2-SELF packet within the buffering time (i.e., from time t₆ to t₆+2 milliseconds). Meanwhile, the BT module 420 continues the BT communications at time t₆.

At time t7, the BT module 420 determines to stop the BT communications early before the end of the requested time slice. In response, the WiFi module 410 sends out a CF-END packet to free the WiFi channel from being reserved for BT communications, and starts the WiFi Rx operation for 2.5 milliseconds.

In view of the forgoing embodiment of FIGS. 6 and 7, it will be appreciated that the present application realizes successful extension of BT communications for BT successive bursts occurring at the end of granted time slice, by adding a buffering time to the requested time slice. Advantageously, the buffering time allows the CTS-2-SELF packet to be sent out in time, which solves the problem of WiFi downstream throughput degradation in the conventional design. Furthermore, the present application realizes efficient utilization of the air time, by using the CF-END packet to give back the air time to WiFi communications in response to early termination of the BT communications.

While the application has been described by way of example and in terms of preferred embodiment, it is to be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A wireless communication system, comprising:
a first circuit configured to support a first wireless communication using a first wireless technology; and
a second circuit configured to support a second wireless communication using a second wireless technology, determine a period of time for an activity schedule of the first wireless communication, send out a first control packet for channel reservation for the period of time plus a buffering time in response to detecting the activity schedule of the first wireless communication, and send out a second control packet within the buffering time for additional channel reservation in response to the activity schedule of the first wireless communication being extended.

2. The wireless communication system as claimed in claim 1, wherein the first wireless technology is a Bluetooth (BT) technology, and the second wireless technology is a Wireless Fidelity (WiFi) technology.

3. The wireless communication system as claimed in claim 2, wherein each of the first control packet and the second control packet is a respective CLEAR TO SEND (CTS)-TO-SELF (CTS-2-SELF) packet.

4. The wireless communication system as claimed in claim 3, wherein the first CTS-2-SELF packet comprises a Network Allocation Vector (NAV) duration set to a value of the period of time plus the buffering time, and the second CTS-2-SELF packet comprises another NAV duration set to a value of an extended period of time plus the buffering time.

5. The wireless communication system as claimed in claim 1, wherein the second circuits are further configured to send out a third control packet within the period of time for channel reservation cancellation in response to the first activity schedule of the first wireless communication being cut short.

6. The wireless communication system as claimed in claim 5, wherein the first wireless technology and the second wireless technology are a Bluetooth (BT) technology and a Wireless Fidelity (WiFi) technology, respectively, and the third control packet is a Contention Free-END (CF-END) packet.

7. The wireless communication system as claimed in claim 1, wherein the buffering time is configurable to enable the second control packet to be sent out successfully.

8. A method for operation coordination of a wireless communication system, wherein the wireless communication system comprises a first circuit configured to support a first wireless communication using a first wireless technology and a second circuit configured to support a second wireless communication using a second wireless technology, the method comprising:
determining a period of time for an activity schedule of the first wireless communication;
sending out a first control packet for channel reservation for the period of time plus a buffering time in response to detecting the activity schedule of the first wireless communication; and
sending out a second control packet within the buffering time for additional channel reservation in response to the activity schedule of the first wireless communication being extended.

9. The method as claimed in claim 8, wherein the first wireless technology is a Bluetooth (BT) technology, and the second wireless technology is a Wireless Fidelity (WiFi) technology.

10. The method as claimed in claim 9, wherein each of the first control packet and the second control packet is a respective CLEAR TO SEND (CTS)-TO-SELF (CTS-2-SELF) packet.

11. The method as claimed in claim 10, wherein the first CTS-2-SELF packet comprises a Network Allocation Vector (NAV) duration set to a value of the period of time plus the buffering time, and the second CTS-2-SELF packet comprises another NAV duration set to a value of an extended period of time plus the buffering time.

12. The method as claimed in claim 8, further comprising:
sending out a third control packet within the period of time for channel reservation cancellation in response to the first activity schedule of the first wireless communication being cut short.

13. The method as claimed in claim 12, wherein the first wireless technology and the second wireless technology are a Bluetooth (BT) technology and a Wireless Fidelity (WiFi) technology, respectively, and the third control packet is a Contention Free-END (CF-END) packet.

14. The method as claimed in claim 8, wherein the buffering time is configurable to enable the second control packet to be sent out successfully.
